(19) United States
(12) Patent Application Publication
(10) Pub. No.: US 2003/0051240 A1
(43) Pub. Date: Mar. 13, 2003

(54) Four-way recommendation method and system including collaborative filtering

(75) Inventors: J. David Schaffer, Wappingersfalls, NY (US); Srinivas Gutta, Buchanan, NY (US); Kaushal Kurapati, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/953,385

(22) Filed: Sep. 10, 2001

(51) Int. Cl. H04N 7/16; H04H 9/00; H04N 7/025; H04N 7/10

(52) U.S. Cl. 725/34; 725/35; 725/9; 725/46

(57) ABSTRACT

A system employing an automated collaborative filtering process for recommending an item to a viewer based upon feedback data, implicit data, and/or explicit data corresponding to a primary viewer as well as secondary viewers is disclosed. A first act of the automated collaborative filtering process is to match data indicative of a viewing of a first group of items by the primary viewer to data indicative of a viewing of a second group of items by the secondary viewers. A second act of the automated collaborative filtering process is to generate a recommendation of the item by the primary viewer as a function of data indicative of one or more attributes of the item as compared to the data matching accomplished in the first act.

### BACKGROUND OF THE INVENTION

1. Field of the Invention

The present invention generally relates to systems that employ an electronic program guide to assist a media viewer in managing a large number of media-content choices (e.g., television programming, chatrooms, on-demand video media files, audio, etc.). The present invention specifically relates to systems having the “intelligence” to suggest choices to a viewer and to take actions based on the suggestions (e.g., record a program on behalf of the viewer).

2. Description of the Related Art

A conventional electronic program guide displays a listing of programs for many available channels. The listing may be generated locally and displayed interactively. The listing is commonly arranged in a grid. Each row of the grid represents a particular broadcast channel or cable channel (e.g., NBC, CBS, ABC, PBS, CNN, ESPN, HBO, MAX, etc.). Each column of the grid represents a particular time slot (e.g., 30 minute time slots starting from 12:00 a.m.). Multiple rows and multiple columns can be displayed on the screen simultaneously. The various scheduled programs or shows are arranged within the rows and columns to thereby indicate the channels and times at which they can be individually found. The grid can be scrolled vertically so that a viewer can scan through different channels within a given interval of time. The grid may also be scrolled horizontally (panned) to change the time interval displayed.

Data regarding available programs may be received by a cable system or telephone line as a set of data records. Each available program may have a single corresponding data record containing information about the program such as its channel, its starting and ending times, its title, names of starring actors, whether closed-captioning and stereo are available, and perhaps a brief description of the program. It is not difficult to format a grid such as described above from these types of data records. The data spanning a period (e.g., two weeks) are typically formatted once at the server (e.g., the cable system's head-end) and broadcast repeatedly and continuously to the homes served by the cable system. Alternatively, the data may be downloaded via phone line, or other network, either on-demand or on a predetermined schedule.

An electronic program guide system can run on a device with a viewer interface (hereinafter a “viewer interface device”). The viewer interface device can be in the form of a set-top box (STB), a general purpose computer, an embedded system, a controller within the television, or the server of a communications network or Internet server. The viewer interface device is connected to the TV to generate displays and receive inputs from the viewer. When scrolling to a new column or row, the viewer interface device may retrieve appropriate information from a stored database (in the viewer interface device or elsewhere) regarding the programming information that needs to be presented for the new row or column. For instance, when scrolling to a new column, programs falling within a new time slot need to be displayed.

An electronic program guide facilitates the management of choosing from among the myriad television and other media viewing choices. An interactive application of an electronic program guide builds a viewer-preference database and uses the preference data to make suggestions, filter current or future programming information to simplify the job of choosing, or even make choices on behalf of the viewer. For example, the system could record a program without a specific request from the viewer or highlight choices that it recommends.

A first type of device for building a preference database is an implicit profiler. The viewer merely makes choices in the normal fashion from raw electronic program guide data and the implicit profiler gradually builds a personal preference database by extracting a model of the viewer's behavior from the choices. A recommender then uses the model to make predictions about what the viewer would prefer to watch in the future. This extraction process can follow simple algorithms, such as identifying apparent favorites by detecting repeated requests for the same item, or it can be a sophisticated machine-learning process such as a decision-tree technique with a large number of inputs (degrees of freedom). Such models, generally speaking, look for patterns in the viewer's interaction behavior (i.e., interaction with the viewer-interface device for making selections).

One technique implemented by an implicit profiler for extracting useful information from the viewer's pattern of watching is to generate a table of attribute-value counts. An example of an attribute is the “time of day” and a corresponding value could be “morning.” When a choice is made, the counts of the attribute-values characterizing that choice are incremented. Usually, a given choice will have many attribute-values. A set of negative choices may also be generated by selecting a subset of shows (optionally, at the same time) from which the choice was discriminated. Their respective attribute-value counts will be decremented (or a count for shows not watched incremented). This data is sent to an implicit profiler in the form of a Bayesian predictor that uses the counts as weights to feature-counts characterizing candidates to predict the probability that a candidate will be preferred by a viewer. An example of a Bayesian predictor is described in U.S. patent application Ser. No. 09/498,271, filed Feb. 4, 2000, entitled “BAYESIAN TV SHOW RECOMMENDER”, the entirety of which is hereby incorporated by reference as if fully set forth herein. A rule-based implicit profiler, which builds implicit profiles passively from observations of viewer behavior, is also described in a PCT application, World Organization No. 99/01984 published Jan. 14, 1999, entitled “INTELLIGENT ELECTRONIC PROGRAM GUIDE.”

Another example of the implicit profiler is the one incorporated in MbTV, a system that learns viewers' television watching preferences by monitoring their viewing patterns. MbTV operates transparently and builds a profile of a viewer's tastes. This profile is used to provide services, for example, recommending television programs the viewer might be interested in watching. MbTV learns about each of its viewer's tastes and uses what it learns to recommend upcoming programs. MbTV can help viewers schedule their television watching time by alerting them to desirable upcoming programs, and with the addition of a storage device, automatically record these programs when the viewer is absent.

MbTV has a Preference Determination Engine and a Storage Management Engine. These are used to facilitate time-shifted television. MbTV can automatically record, rather than simply suggest, desirable programming. MbTV's Storage Management Engine tries to insure that the storage device has the optimal contents. This process involves tracking which recorded programs have been viewed (completely or partially), and which are ignored. Viewers can “lock” recorded programs for future viewing in order to prevent deletion. The ways in which viewers handle program suggestions or recorded content provides additional feedback to MbTV's preference engine which uses this information to refine future decisions.

MbTV will reserve a portion of the recording space to represent each “constituent interest.” These “interests” may translate into different family members or could represent different taste categories. Though MbTV does not require viewer intervention, it is customizable by those that want to fine-tune its capabilities. Viewers can influence the “storage budget” for different types of programs. For example, a viewer might indicate that, though the children watch the majority of television in a household, no more than 25% of the recording space should be consumed by children's programs.

A second type of device for building a preference database is an explicit profiler. The explicit profiler permits the viewer to specify likes or dislikes by grading features. These can be a scoring of attribute-value pairs (e.g., a 7 for extremely like on a scale of 1-7 for an attribute of actor and a value of John Wayne) or some other rule-specification such as combinations of attribute-value pairs like “I like documentaries, but not on Thursday which is the night when the gang comes over.” For example, the viewer can indicate, through the viewer interface device, that dramas and action movies are favored and that certain actors are disfavored. These criteria can then be applied to predict which, from among a set of programs, would be preferred by the viewer.

EP application (EP 0854645A2) discloses a system having an explicit profiler that enables a viewer to enter generic preferences such as a preferred program category, for example, sitcom, dramatic series, old movies, etc. The application also describes preference templates in which preference profiles can be selected, for example, one for children aged 10-12, another for teenage girls, and another for airplane hobbyists, etc.

A third type of device for building a preference database is a feedback profiler. For example, currently, TiVo® permits viewer's to give a show up to three thumbs up or up to three thumbs down. A PCT application, WO 97/4924, entitled “System and Method for Using Television Schedule Information” is an example of a system incorporating a feedback profiler. The application describes a system in which a viewer can navigate through an electronic program guide displayed in the usual grid fashion and select various programs. At each point, he/she may be doing any of various described tasks, including, selecting a program for recording or viewing, scheduling a reminder to watch a program, and selecting a program to designate as a favorite. Designating a program as a favorite is for the purpose, presumably, to implement a fixed rule such as: “Always display the option of watching this show” or to implement a recurring reminder. The purpose of designating favorites is not clearly described in the application. However, more importantly, for purposes of creating a preference database, when the viewer selects a program to designate as a favorite, she/he may be provided with the option of indicating the reason it is a favorite. The reason is indicated in the same fashion as other explicit criteria: by defining generic preferences.

An implicit profiling system has the advantage of being easier on the viewer since the viewer does not have to provide any feedback data or explicit data. The viewer merely interacts with the system. An explicit profiling system and a feedback profiling system have the advantage of providing explicit preference information. The explicit profiling system is reliable, but not perfect as a viewer may have a hard time abstracting his own preferences to the point of being able to decide which criteria are good discriminators and what weight to give them. The feedback profiling system probably provides the best quality of information, but can be a burden to generate and still may not contain all the information that can be obtained with an explicit profiling system and also may require information on many shows like an implicit profiling system.

Additionally, the feedback type and the implicit type of profiling systems experience what is known as a “cold start” with a viewer. Specifically, a degree of effectiveness of these types of profiling systems in building a viewer preference database increases with a maturity in the interaction between the system and the viewer. Thus, the degree of effectiveness of each type of profiling system in building a viewer preference database is limited during the early stages of the interaction between the system and the viewer.

One way for addressing the “cold start” scenario is the utilization of an automated collaborative filtering system such as the systems disclosed in U.S. Pat. Nos. 4,996,642 and 5,790,426. In response to a viewer requesting a recommendation of an unviewed item, these prior art systems are based upon ratings of viewed items by the requesting viewer as well as ratings of viewed items by a group of secondary viewers. However, these prior art systems do not give any direct consideration to specific features of the unviewed item and the viewed items. Consequently, the recommendation provided to the viewer can diverge from the viewer's opinion of specific features of the unviewed item. In addition, the unviewed item may not be included within the viewed items by the group of secondary viewers. However, the prior art systems provide no methods for generating recommendations for items unviewed by the group of secondary viewers. The present invention addresses these problems.

### SUMMARY OF THE INVENTION

The present invention relates to a four-way media recommendation method and system including a collaborative filter that overcomes the disadvantages associated with the prior art. In particular, the present invention facilitates an application of collaborative filtering of items that have not been rated by any user of the system. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is an automated collaborative filtering method for providing a recommendation of an item by a primary viewer. First, data indicative of a viewing of a first group of items by the primary viewer is matched to a subset of data indicative of a viewing of a second group of items by a group of secondary viewers. Second, the recommendation of the item is generated as a function of the subset of the matched data as well as data indicative of one or more attributes of the item.

A second form of the present invention is an automated collaborative filtering system for providing a recommendation of an item to a primary viewer. The system comprises a first module for matching data indicative of a viewing of a first group of items by the primary viewer to a subset of data indicative of a viewing of a second group of items by a group of secondary viewers. The system further comprises a second module for generating the recommendation of the unviewed item as a function of data indicative of one or more attributes of the first item and the subset of the matched data.

A third form of the present invention is a computer program product in a computer readable medium for providing a recommendation of an item to a primary viewer. The computer program product comprises computer readable code for matching data indicative of a viewing of a first group of items by the primary viewer to a subset of data indicative of a viewing of a second group of items by group of secondary viewers. The computer program product further comprises computer readable code for generating the recommendation of the item as a function of data indicative of one or more attributes of the item, and the subset of the matched data.

The foregoing forms and other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a schematic diagram of one embodiment in accordance with the present invention of an automated collaborative filtering system;

FIG. 2 illustrates a block diagram of one embodiment in accordance with the present invention of a computer hardware employed within the FIG. 1 system;

FIG. 3A illustrates a flow chart of a profiling routine of the present invention;

FIG. 3B illustrates a flow chart of a program recommendation routine of the present invention;

FIG. 4A illustrates a block diagram of one embodiment of a feedback recommendation software employed within the FIG. 1 system for implementing the FIG. 3A routine;

FIG. 4B illustrates a block diagram of one embodiment of an implicit profiling software employed within the FIG. 1 system for implementing the FIG. 3A routine;

FIG. 4C illustrates a block diagram of one embodiment of an explicit profiling software employed within the FIG. 1 system for implementing the FIG. 3A routine;

FIG. 5 illustrates a flow chart of a collaborative filtering routine of the present invention;

FIG. 6A illustrates a block diagram of a first embodiment of a feedback filtering software employed within the FIG. 1 system for implementing the FIG. 5 routine;

FIG. 6B illustrates a block diagram of a second embodiment of a feedback filtering software employed within the FIG. 1 system for implementing the FIG. 5 routine;

FIG. 6C illustrates a block diagram of a first embodiment of an implicit filtering software employed within the FIG. 1 system for implementing the FIG. 5 routine;

FIG. 6D illustrates a block diagram of a second embodiment of an implicit filtering software employed within the FIG. 1 system for implementing the FIG. 5 routine;

FIG. 6E illustrates a block diagram of one embodiment of an explicit filtering software employed within the FIG. 1 system for implementing the FIG. 5 routine; and

FIG. 6F illustrates a block diagram of various embodiments of a combination filtering software employed within the FIG. 1 system for implementing the FIG. 5 routine.

### DETAILED DESCRIPTION OF THE PRESENTLY PREFERRED EMBODIMENTS

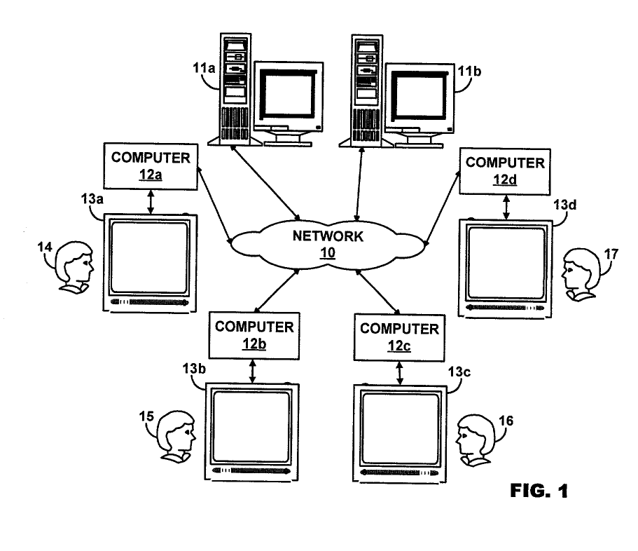

An automated collaborative filtering system of the present invention is shown in FIG. 1. The system comprises a network 10 which is the media used to provide communications links between an application server 11a, a database server 11b, a viewer computer 12a, a viewer computer 12b, a viewer computer 12c, and a viewer computer 12d. Network 10 may include permanent connections, such as wire or fiber optic cables, or temporary connections made through telephone or wireless communications. Network 10 may be in the form of the Internet, an extranet, an intranet, a local area network (LAN), a wide area network (WAN), or other forms as would occur to those having ordinary skill in the art.

Viewer computers 12a-12d are in communication (temporary or permanent) with a group of televisions 13a-13d, respectively, that are utilized by group of secondary viewers 14-17, respectively, to view television programs.

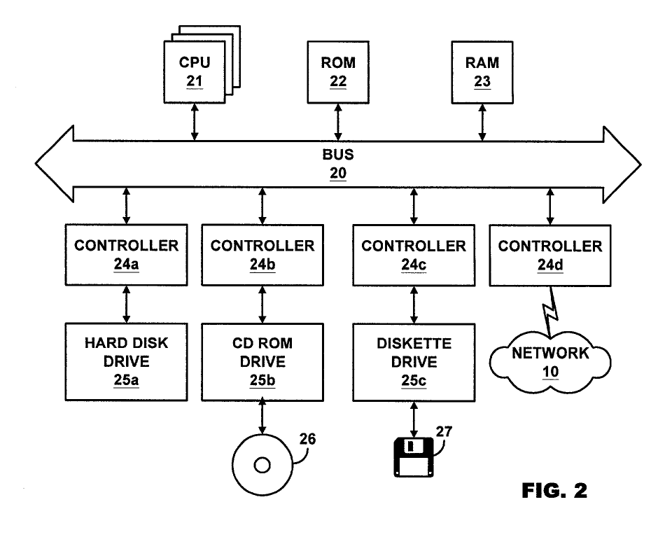

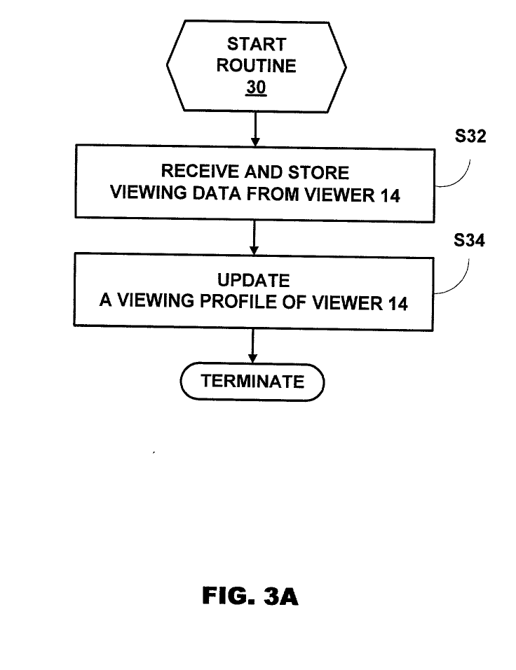

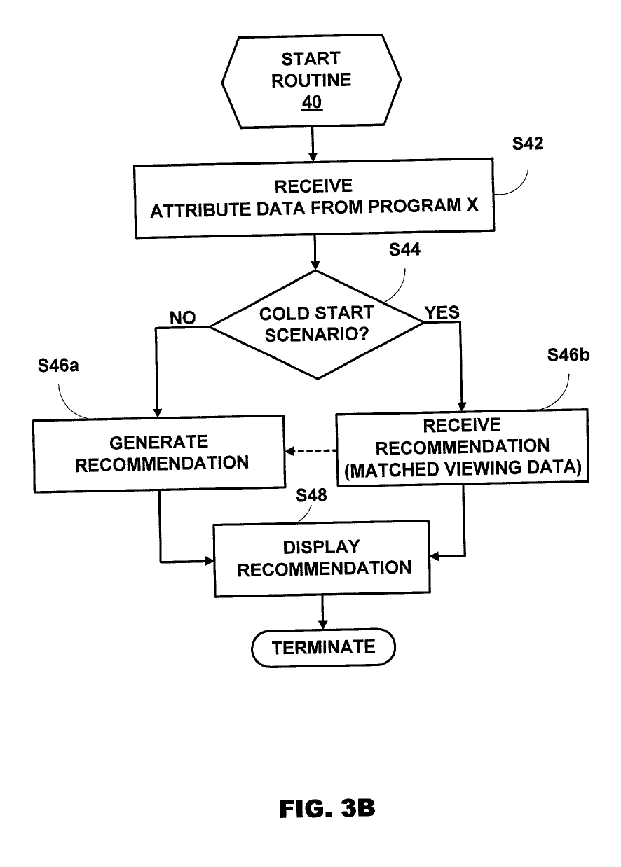

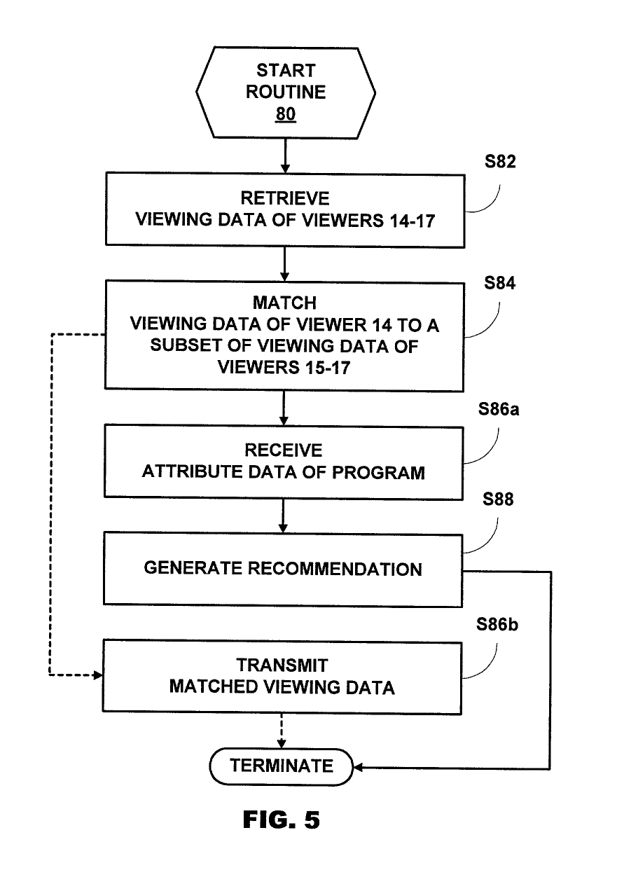

Application server 11a and database server 11b may be configured in any form for accepting structured inputs, processing the inputs in accordance with prescribed rules, and outputting the processing results to implement a profiling routine 30 (FIG. 3A) and a program recommendation routine 40 (FIG. 3B) of the present invention. Viewer computers 12a-12d may be configured in any form for accepting structured inputs, processing the inputs in accordance with prescribed rules, and outputting the processing results to implement a collaborative filtering routine 80 (FIG. 5) of the present invention. One embodiment of computer hardware employed within application server 11a, application server 11b, and viewer computers 12a-12d is illustrated in FIG. 2. The computer hardware includes a bus 20 for facilitating electrical communication among one or more central processing units (CPU) 21, a read-only memory (ROM) 22, a random access memory (RAM) 23, and controllers 24a-24d.

Each CPU 21 is preferably one of the Intel families of microprocessors, one of the AMD families of microprocessors, or one of the Motorola families of microprocessors. ROM 22 permanently stores various controlling programs. RAM 23 is the memory for loading a conventional operating system and selectively loading the controlling programs.

Controller 24a conventionally facilitates an interaction between CPU 21 and a hard disk drive 25a. The hard disk drive stores the conventional operating system and application programs. Controller 24b conventionally facilitates an interaction between CPU 21 and a CD ROM drive 25b whereby any programs on a CD ROM disk 26 may be installed on the hardware. Controller 24b conventionally facilitates an interaction between CPU 21 and a diskette drive 25c whereby any programs on a diskette 27 may be installed on the hardware. Controller 24d conventionally facilitates an interaction between CPU 21 and network 10.

To implement the principles of the present invention, the computer hardware illustrated in FIG. 2 can include additional hardware components as would occur to those having ordinary skill in the art. Additionally, as would occur to those having ordinary skill in the art, application server 11a, application server 11b, and viewer computers 12a-12d may have a modified version of the computer hardware shown in FIG. 2 or an alternative embodiment thereof.

Profiling routine 30 (FIG. 3A) and program recommendation routine 40 (FIG. 3B) will now be described herein in the context of viewing data corresponding to viewer 14, and collaboration filtering routine 80 (FIG. 5) will now be described herein in the context of viewing data corresponding to viewers 14-17. However, those having ordinary skill in the art will appreciate the execution of routine 30 and routine 80 in scenarios where a significant number of viewers (e.g., 100-10,000) are actively involved in an automated collaborative filter system of the present invention.

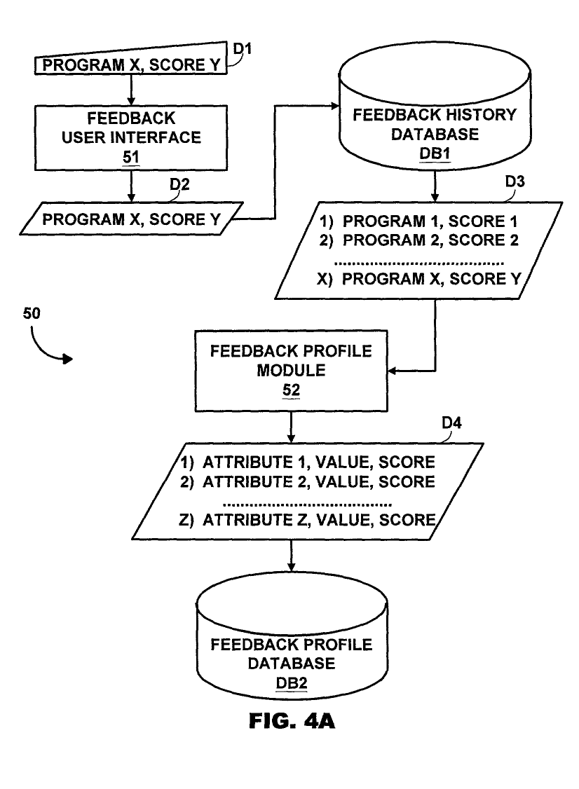

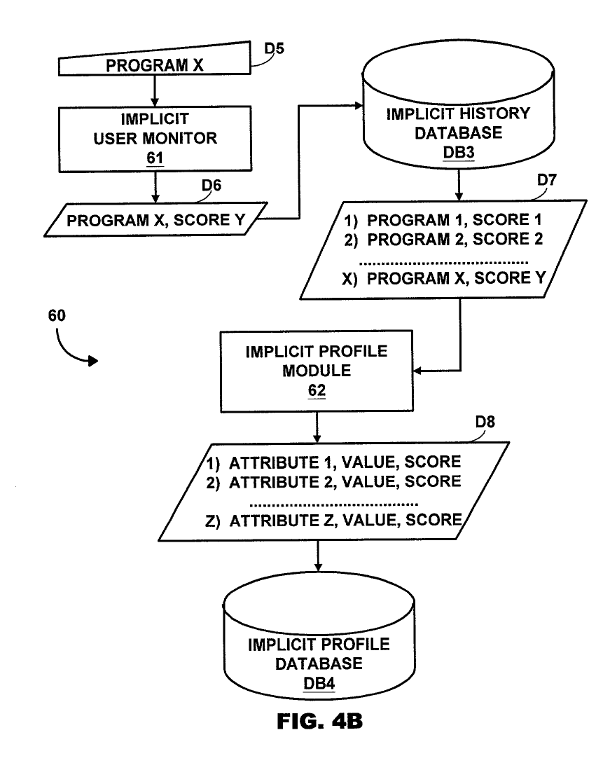

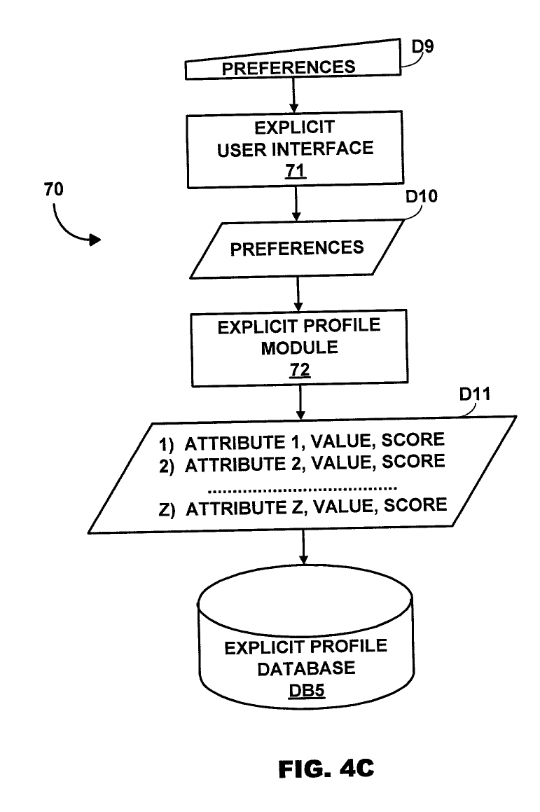

Routine 30 as illustrated in FIG. 3A can be implemented in many forms, such as, for example, a feedback profiling software 50 (FIG. 4A), an implicit profiling software 60 (FIG. 4B), and an explicit profiling software 70 (FIG. 4C). A computer readable medium of viewing computer 12a (e.g., hard disk drive 25a, CD ROM disk 26, floppy disk 27, or any other form) is electrically, magnetically, optically or chemically altered to contain computer readable code corresponding to software 50, software 60, and/or software 70. Alternatively, software 50, software 60, and/or software 70 can be partially or fully implemented within viewing computer 12a by analog circuitry, digital circuitry or both.

During a stage S32 of routine 30, viewing computer 12a receives and stores viewing data corresponding to viewer 14. As illustrated in FIG. 4A, during stage S32, software 50 includes a conventional feedback user interface 51 for receiving a viewing data D1 in the form of a program X and a score Y, and for formatting viewing data D1 into viewing data D2 that is stored within a feedback history database DB1. As illustrated in FIG. 4B, during stage S32, software 60 includes a conventional implicit user monitor 61 for receiving a viewing data D5 in the form of a program X, and for formatting viewing data D5 into viewing data D6 that is stored within an implicit history database DB3. As illustrated in FIG. 4C, during stage S32, software 70 includes a conventional explicit user interface 71 for receiving a viewing data D9 in the form of viewer preferences, and for formatting viewing data D9 into viewing data D10.

During a stage S34 of routine 30, viewing computer 12a updates a viewing profile of viewer 14. As illustrated in FIG. 4A, during stage S34, software 50 includes a conventional feedback profile module 52 for generating a feedback profile data D4 in response to a feedback history data D3 and storing feedback profile data D4 within a feedback profile database DB2. As illustrated in FIG. 4B, during stage S34, software 60 includes a conventional implicit profile module 62 for generating an implicit profile data D8 in response to an implicit history data D7 and storing implicit profile data D8 within an implicit profile database DB4. As illustrated in FIG. 4C, during stage S34, software 70 includes a conventional explicit profile module 72 for generating an explicit profile data D11 in response to viewing data D10 and storing explicit profile data D11 within an explicit profile database DB5.

Software 50, software 60, and software 70 terminate routine 30 after a completion of stage S34.

Routine 40 as illustrated in FIG. 3B can be implemented in many forms under the principles of the present invention, such as, for example, a program recommendation process described in U.S. patent application Ser. No. 09/466,406, filed Dec. 17, 1999, entitled “Method and Apparatus for Recommending Television Programming Using Decision Tree”, and U.S. patent application Ser. No. 09/498,271 filed Feb. 4, 2000, entitled “Bayesian TV Show Recommender”, each being assigned to the assignee of the present invention and entirety of which is incorporated by reference herein. A computer readable medium of viewing computer 12a (e.g., hard disk drive 25a, CD ROM disk 26, floppy disk 27, or any other form) is electrically, magnetically, optically or chemically altered to contain computer readable code corresponding to software implementing routine 40. Alternatively, the software can be partially or fully implemented within viewing computer 12a by analog circuitry, digital circuitry or both.

During a stage S42 of routine 40, viewing computer 12 receives attribute data corresponding to a program X. During a stage S44 of routine 50, viewing computer 12a determines if viewer 14 is experiencing a cold start scenario. In one embodiment, viewing computer 12a determines viewer 14 is experiencing a cold start scenario when viewing computer 12a has provided fewer than a fixed number of recommendations to viewer 14 (e.g., less than twenty recommendations).

When viewing computer 12a determines viewer 14 is not experiencing a cold start scenario during stage S44, viewing computer 12a conventionally generates a recommendation of the program in accordance with U.S. patent application Ser. No. 09/466,406 or U.S. patent application Ser. No. 09/498,271 during a stage S46a of routine 40 and displays the recommendation during stage S46.

When viewing computer 12a determine viewer 14 is experiencing a cold start scenario during stage S44, viewing computer 12a proceeds to a stage S46b of routine 40 to either receive a recommendation of program X from application server 11a which is displayed during stage S48 or receive viewing data corresponding to one or more of viewers 15-17 from application server 11a which is used to generate a recommendation of program X during stage S46a. Application server 11 a provides the recommendation of the program or the viewing data as a result of an execution of routine 80 (FIG. 5).

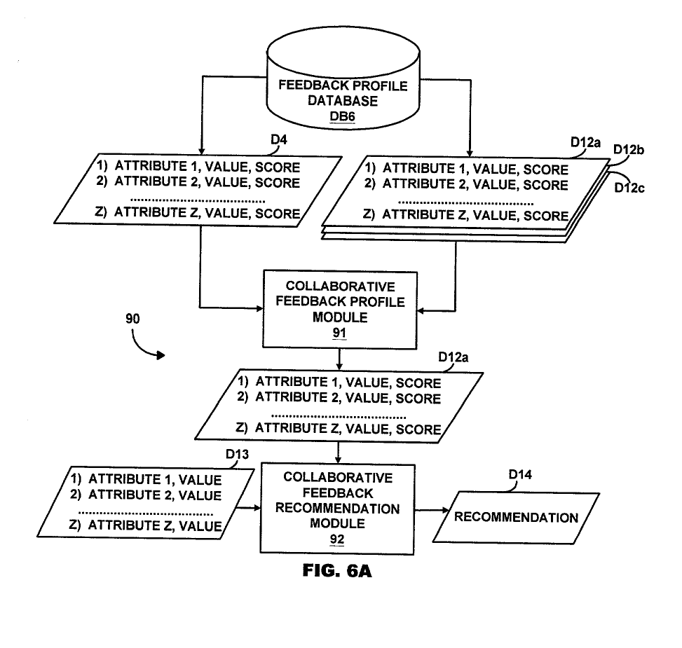

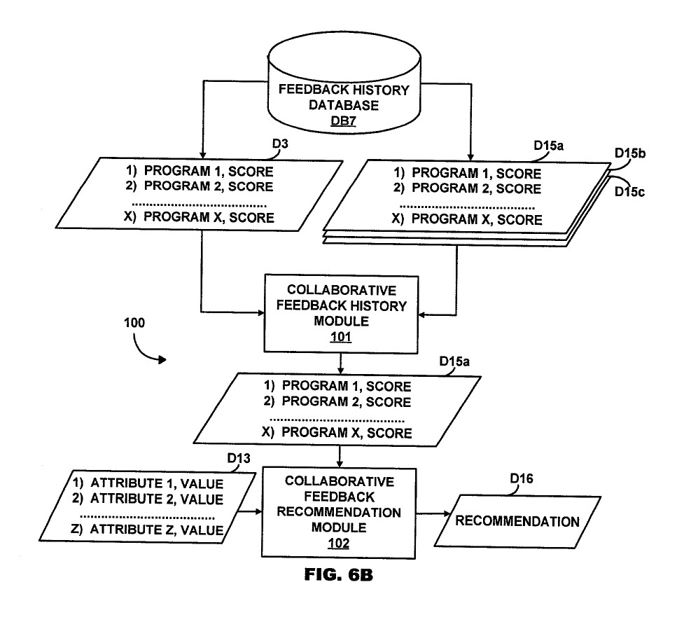

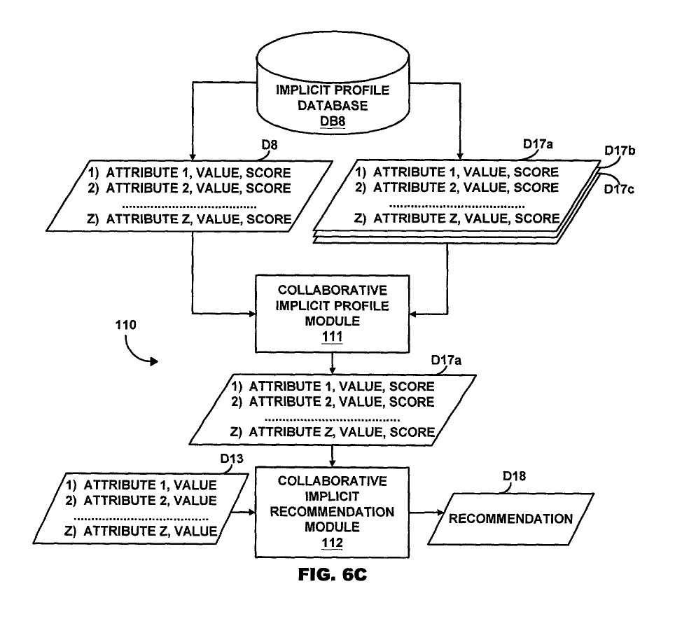

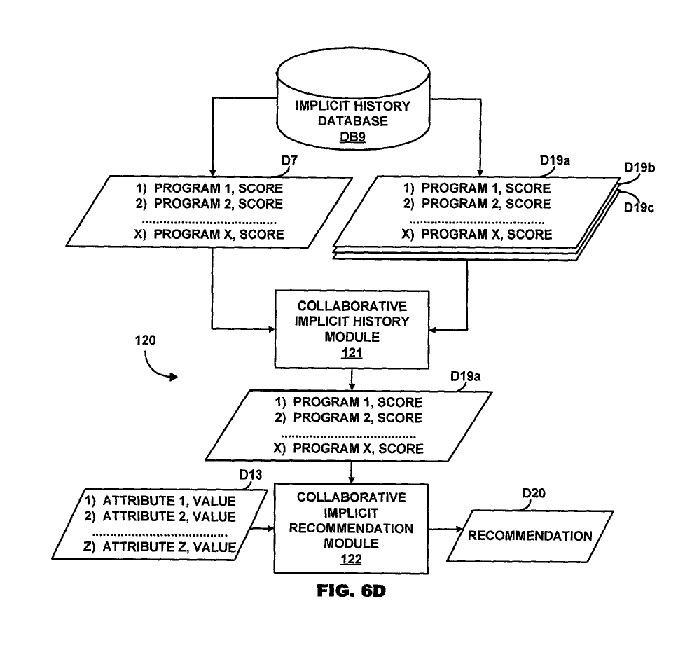

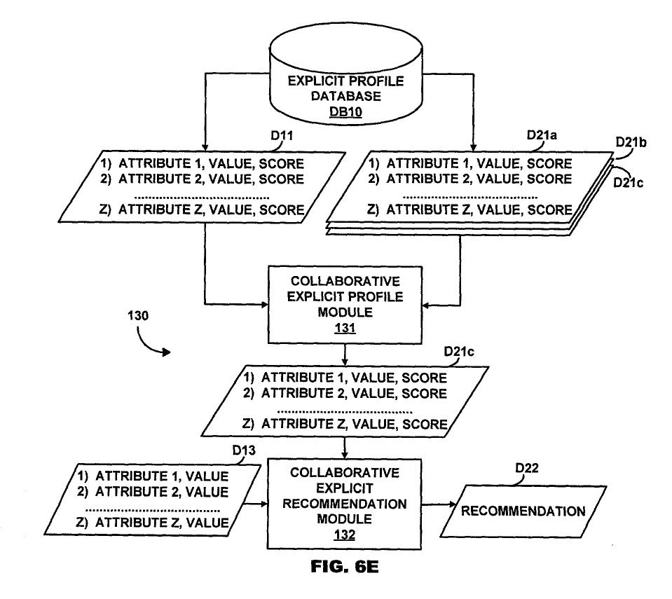

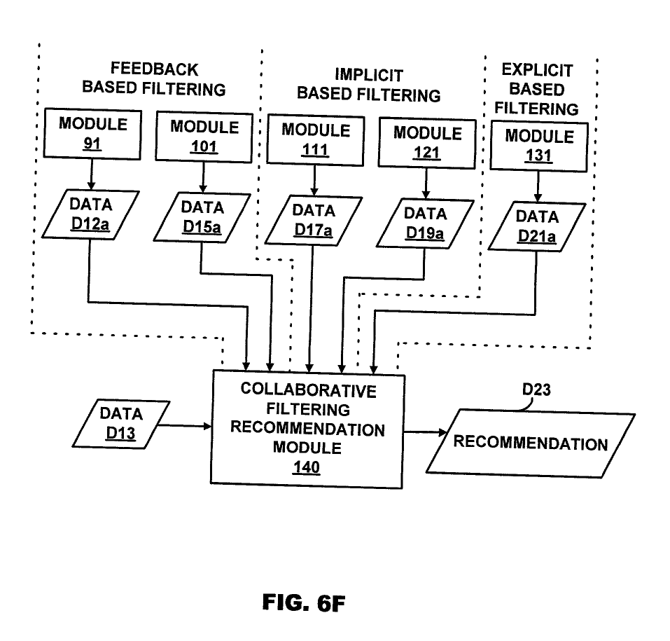

Routine 80 as illustrated in FIG. 5 can be implemented in many forms, such as, for example, a feedback filtering software 90 (FIG. 6A), a feedback filtering software 100 (FIG. 6B), an implicit filtering software 110 (FIG. 6C), an implicit filtering software 120 (FIG. 6D), and an explicit filtering software 130 (FIG. 6E). A computer readable medium of application server 11a (e.g., hard disk drive 25a, CD ROM disk 26, floppy disk 27, or any other form) is electrically, magnetically, optically or chemically altered to contain computer readable code corresponding to software 90, software 100, software 110, software 120, and/or software 130. Alternatively, software 90, software 100, software 110, software 120, and/or software 130 can be partially or fully implemented within application server 11a by analog circuitry, digital circuitry or both.

During a stage S82 of routine 80, application server 11a retrieves viewing data corresponding to viewer 14 (primary) and viewers 15-17 (secondary) from database server 11b. A storage of the viewing data corresponding to viewers 14-17 within database server 11b via network 10 (FIG. 1) can occur on a fixed or random schedule. Preferably, database server 11b stores the more current version of the viewing data corresponding to viewers 14-17 in response to an initiation of routine 80 by application server 11a.

As illustrated in FIG. 6A, during stage S82, a collaborative feedback profile module 91 of software 90 retrieves viewing data D4 corresponding to viewer 14 as well as a viewing data D12a-D12c corresponding to viewers 15-17, respectively, from a feedback profile database DB6 of database server 11b.

As illustrated in FIG. 6B, during stage S82, a collaborative feedback history module 101 of software 100 retrieves viewing data D3 corresponding to viewer 14 as well as viewing data D15a-D15c corresponding to viewers 15-17, respectively, from a feedback history database DB7 of database server 11b.

As illustrated in FIG. 6C, during stage S82, a collaborative implicit profile module 111 of software 110 retrieves viewing data D8 corresponding to viewer 14 as well as a viewing data D17a-D17c corresponding to viewers 15-17, respectively, from an implicit profile database DB8 of database server 11b.

As illustrated in FIG. 6D, during stage S82, a collaborative implicit history module 121 of software 120 retrieves viewing data D7 corresponding to viewer 14 as well as viewing data D19a-D19c corresponding to viewers 15-17, respectively, from an implicit history database DB9 of database server 11b.

As illustrated in FIG. 6E, during stage S82, a collaborative explicit profile module 131 of software 130 retrieves viewing data D11 corresponding to viewer 14 as well as viewing data D21a-D21c corresponding to viewers 15-17, respectively, from an explicit profile database DB10 of database server 11b.

During a stage S84 of routine 80, application server 11 a matches viewing data of viewer 14 to a subset of viewing data of viewers 15-17.

In one embodiment, module 91 of software 90 executes the following series of steps during stage S84 when determining whether viewer 14 and viewer 15 having matching viewing data.

First, a fb_score(j) is incremented by one when the following equation [1] is satisfied for each feature (f) of the attribute-value pairs entries having a probability above a noise cutoff in viewing data D4 and viewing data D12a:

{cp_{—}i(f)−cp_{—}j(f)}<cp_threshold for class C+ [1]

where i designates viewer data D4; j designates viewing data D12a; cp_j(f) is the conditional probability of a feature (f) from viewing data D4; cp_j(f) is the conditional probability of a feature (f) from viewing data D12a; and cp_threshold is a number between an exemplary range of 0.0 and 0.10. The actual value of cp_threshold is determined empirically to control the number of actual matches between viewing data D4 and viewing data D12a.

Second, a final value of fb_score(j) is normalized by dividing the total number of features (f) having a probability above a noise cutoff in viewing data D4 into the final value of fb_score(j) to obtain a fbn_score(j) of viewing data D12a between 0.0 and 1.0.

Finally, viewing data D12a is provided to a collaborative feedback recommendation module 92 as illustrated in FIG. 6A when fbn_score(j) of viewing data D12a is greater than a match_threshold, such as, for example, 0.9.

Module 91 thereafter determines whether viewing data D4 matches viewing data D12b and viewing data D12c under the same series of steps. Accordingly, the match_threshold can be determined empirically and fixed whereby the sample size of viewing data matches may vary with each execution of program 90. Alternatively, the match_threshold can be dynamically varied whereby the sample size of viewing data matches approximate a desired sample size with each execution of program 90.

In a second embodiment, module 101 of software 100 executes the following series of steps during stage S84 when determining whether viewer 14 and viewer 15 having matching viewing data.

First, a score (B,A) is computed from the following equation [2]:

fb_score(B,A)=match (pos(B),pos(A))/n_pos(B) [2]

where pos(A) are programs within feedback data D3 having a positive score; pos (B) are the programs within viewing data D15a having a positive score; n_pos(B) is the number of programs within viewing data D3; and match ((pos(B),pos(A)) is the number of programs listed within both pos(A) and pos (B).

Second, viewing data D15a is provided to a collaborative feedback recommendation module 102 as illustrated in FIG. 6B when fb_score(B,A) of viewing data D15a is greater than a match threshold, such as, for example, 0.9.

Module 101 thereafter determines whether viewing data D3 matches viewing data D15b and viewing data D15c under the same series of steps. Accordingly, the match_threshold can be determined empirically and fixed whereby the sample size of viewing data matches may vary with each execution of program 100. Alternatively, the match_threshold can be dynamically varied whereby the sample size of viewing data matches approximate a desired sample size with each execution of program 100.

In a third embodiment, module 111 of software 110 executes the following series of steps during stage S84 when determining whether viewer 14 and viewer 15 having matching viewing data.

First, an im_score(j) is incremented by one when equation [1] is satisfied for each feature (f) of the attribute-value pairs entries having a probability above a noise cutoff in viewing data D8 and viewing data D17a:

{cp_{—}i(f)−cp_{—}j(f)}<cp_threshold for class C+ [1]

where i designates viewer data D8; j designates viewing data D17a; cp_i(f) is the conditional probability of a feature (f) from viewing data D8; cp_j(f) is the conditional probability of a feature (f) from viewing data D17a; and cp_threshold is a number between an exemplary range of 0.0 and 0.10. The actual value of cp_treshold is determined empirically to control the number of actual matches between viewing data D8 and viewing data D17a.

Second, a final value of im_score(j) is normalized by dividing the total number of features (f) having a probability above a noise cutoff in viewing data D8 into the final value of im_score(j) to obtain a imn_score(j) of viewing data D17a between 0.0 and 1.0.

Finally, viewing data D17a is provided to a collaborative implicit recommendation module 112 as illustrated in FIG. 6c when im_score(j) of viewing data D17a is greater than a match_threshold, such as, for example, 0.9.

Module 111 thereafter determines whether viewing data D8 matches viewing data D17b and viewing data D17c under the same series of steps. Accordingly, the match_threshold can be determined empirically and fixed whereby the sample size of viewing data matches may vary with each execution of program 110. Alternatively, the match_threshold can be dynamically varied whereby the sample size of viewing data matches approximate a desired sample size with each execution of program 110.

In a fourth embodiment, module 121 of software 120 executes the following series of equations during stage S84 when determining whether viewer 14 and viewer 15 having matching viewing data.

First, an im_score (B,A) is computed from the following equation [3]:

im_score(B,A)=match (pos(B),pos(A))/n_pos(B) [3]

where pos(A) are programs within viewing data D7 having a positive score; pos (B) are programs within viewing data D19a having a positive score; n_pos(B) is the number of programs within viewing data D7; and match ((pos(B),pos(A)) is the number of programs listed within both pos(A) and pos (B).

Second, viewing data D19a is provided to a collaborative implicit recommendation module 122 as illustrated in FIG. 6D when im_score(B,A) of viewing data D19a is greater than a match_threshold, such as, for example, 0.9.

Module 121 thereafter determines whether viewing data D7 matches viewing data D19b and viewing data D19c under the same series of steps. Accordingly, the match_threshold can be determined empirically and fixed whereby the sample size of viewing data matches may vary with each execution of program 120. Alternatively, the match_threshold can be dynamically varied whereby the sample size of viewing data matches approximate a desired sample size with each execution of program 120.

In a fifth embodiment, module 131 of software 130 executes the following series of steps during stage S84 when determining whether viewer 14 and viewer 15 having matching viewing data.

First, an ex_score(j) is incremented by one when the following equation [4] is satisfied for each feature (f) of the attribute-value pairs entries in viewing data D11 and view data D21a:

|er_{—}i(f)−er_{—}j(f)|<er_threshold for class C+ [4]

where i designates viewing data D11; j designates viewing data D21a; er_i(f) is an explicit rating of a feature (f) from viewing data D11; er_j(f) is an explicit rating of a feature (f) from viewing data D21a; and er_threshold is either 1 or 2 for example. The actual value of er_threshold is determined empirically to control the number of actual matches between viewing data D11 and viewing data D21a-D21c.

Second, a final value of er_score(j) is normalized by dividing the total number of features (f) having a non-neutral score into the final value of er_score(j) to obtain a ern_score(j) of viewing data D21a between 0.0 and 1.0.

Finally, viewing data D21a is provided to a collaborative feedback recommendation module 132 as illustrated in FIG. 6E when ern_score(j) of viewing data D21a is greater than a match_threshold, such as, for example, 0.9.

Module 131 thereafter determines whether viewing data D11 matches viewing data D21b and viewing data D21c under the same series of steps. Accordingly, the match_threshold can be determined empirically and fixed whereby the sample size of viewing data matches may vary with each execution of program 130. Alternatively, the match_threshold can be dynamically varied whereby the sample size of viewing data matches approximate a desired sample size with each execution of program 130.

During a stage S86a of routine 80, application server 11a receives attribute data corresponding to the program. During a stage S88 of routine 80, application server 11a generates a recommendation of the program as a function of the matched viewing data.

In one embodiment, module 92 retrieves a Bayesian recommender such as the one described in U.S. patent application Ser. No. 09/498,271 from viewing computer 12b to thereby generate a recommendation D14 as a function of viewing data D12a and attribute data D13 as illustrated in FIG. 6A. In scenarios where module 91 determines two or more matches between viewing data D4 and viewing data D12a-D12c, module 92 utilizes the Bayesian recommender from the appropriate viewing computers 12b-12d to generate an individual recommendation from each matched viewing data D12a-D12c. The individual recommendations are then pooled whereby the most prevalent recommendation can serve as recommendation D14, or any scheme for combining the individual recommendations to generate recommendation D14 can be executed, such as, for example an average of the individual recommendations can be computed to generate recommendation D14.

In a second embodiment, module 102 utilizes a Decision Tree recommender such as the one described in U.S. patent application Ser. No. 09/466,406 from viewing computer 12b to thereby generate a recommendation D16 as a function of viewing data D15a and attribute data D13 as illustrated in FIG. 6B. In scenarios where module 101 determines two or more matches between viewing data D3 and viewing data D15a-D15c, module 102 utilizes the Decision Tree recommender from the appropriate viewing computers 12b-12d to generate an individual recommendation from each matched viewing data D15a-D15c. The individual recommendations are then pooled whereby the most prevalent recommendation can serve as recommendation D16, or any scheme for combining the individual recommendations to generate recommendation D16 can be executed, such as, the following equation [5]:

$$R e c o m m ( t , B ) = ( 1 / K ) * S U M {\sum }_{k = 1}^{k = K} s c o r e ( B , k ) * r e c o m m ( t , d t ( k ) ) \qquad [ 5 ]$$

where K is the number of matched viewing data; and recomm (t,dt(k)) is a recommendation from the Decision Tree recommender for show t and user k.

In a third embodiment, module 112 retrieves a Bayesian recommender such as the one described in U.S. patent application Ser. No. 09/498,271 from viewing computer 12b to thereby generate a recommendation D18 as a function of viewing data D17a and attribute data D13 as illustrated in FIG. 6C. In scenarios where module 111 determines two or more matches between viewing data D8 and viewing data D17a-D17c, module 102 utilizes the Bayesian recommender from the appropriate viewing computers 12b-12d to generate an individual recommendation from each matched viewing data D17a-D17c. The individual recommendations are then pooled whereby the most prevalent recommendation can serve as recommendation D18, or any scheme for combining the individual recommendations to generate recommendation D18 can be executed, such as, for example an average of the individual recommendations can be computed to generate recommendation D18.

In a fourth embodiment, module 122 utilizes a Decision Tree recommender such as the one described in U.S. patent application Ser. No. 09/466,406 from viewing computer 12b to thereby generate a recommendation D20 as a function of viewing data D19a and attribute data D13 as illustrated in FIG. 6D. In scenarios where module 121 determines two or more matches between viewing data D7 and viewing data D19a-D19c, module 122 utilizes the Decision Tree recommender from the appropriate viewing computers 12b-12d to generate an individual recommendation from each matched viewing data D19a-D19c. The individual recommendations are then pooled whereby the most prevalent recommendation can serve as recommendation D20, or any scheme for combining the individual recommendations to generate recommendation D20 can be executed, such as, the equation [5] previously described herein.

In a fifth embodiment, module 132 retrieves a Bayesian recommender such as the one described in U.S. patent application Ser. No. 09/498,271 from viewing computer 12b to thereby generate a recommendation D22 as a function of viewing data D21a and attribute data D13 as illustrated in FIG. 6E. In scenarios where module 131 determines two or more matches between viewing data D10 and viewing data D21a-D21c, module 132 utilizes the Bayesian recommender from the appropriate viewing computers 12b-12d to generate an individual recommendation from each matched viewing data D21a-D21c. The individual recommendations are then pooled whereby the most prevalent recommendation can serve as recommendation D22, or any scheme for combining the individual recommendations to generate recommendation D22 can be executed, such as, for example an average of the individual recommendations can be computed to generate recommendation D22.

In response to receiving one of the recommendations D14, D16, D18, D20 and D22 during a stage S46b of routine 40, viewing computer 12 either displays the recommendation during a stage S48 of routine 40 or pools the recommendation with any recommendation generated during stage S46a to display a combined recommendation during stage S48.

Alternative to stage S86a and stage S88, application server 11a can provide the matched viewing data (e.g., viewing data 12a, viewing data 15a, viewing data 17a, viewing data 19a, and viewing data 21a) to viewing computer 12a. In response to receiving one of the matched viewing data during stage S46b, viewing computer 12a utilizes the matched viewing data as an input to a corresponding recommender to thereby generate a recommendation during stage S46 and display the recommendation during stage S48.

Software 90, software 100, software 110, software 120, and software 130 were individually described herein. In one embodiment, two or more of the aforementioned software can be linked to a collaborative filtering recommendation module 140 as illustrated in FIG. 6F to thereby generate a recommendation D23 during stage S86 as a function of viewing data 12a or viewing data 15a, and viewing data 17a or viewing data 19a, and viewing data 21a. In one embodiment, a final score for show j is computed from the following equation [6]:

Final_score(j)=(3*ex_score(j))+(2*fb_score(j))+(1*im_score(j)) [6]

where ex_score(j) is the match score of viewing data D21a from equation [4]; fb score(j) is the match score of viewing data D12a from equation [1]; and im_score(j) is the match score of viewing data 17a from equation [1]. Module 140 thereafter utilizes a proper recommender to provide recommendation D23 to viewing computer 12a.

Those having ordinary skill in the art will appreciate that the present invention as described in connection with FIGS. 1-6F is a collaborative filter that can be applied to real-time events (i.e., events not yet rated by anyone). Those having ordinary skill in the art will further appreciate that the present invention as described in connection with FIGS. 1-6F may be applied in contexts other than program schedule data. For example, the present invention can be applied to generate recommendations for web-cast or media forms other than television such as radio broadcasts. Additionally, the automated collaborative filtering system of the present invention or an alternative embodiment thereof can be used to customize a viewer interface of a web site that provide news articles or sell products. Library browsing is another example. One may envision an online library or journal article database whereby these techniques of the present invention may be employed to limit the range of choices.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. An automated collaborative filtering method for providing a recommendation of a first item to a primary viewer, said method comprising:
matching a first data to a subset of a second data, the first data indicative of a viewing of a first group of items by the primary viewer, the second data indicative of a viewing of a second group of items by a first group of secondary viewers; and
generating the recommendation of the first item as a function of a third data and the subset of the second data, the third data indicative of one or more attributes of the first item.

2. The automated collaborative filtering method of claim 1, wherein:
the first data includes a feedback viewing profile of the primary viewer; and
the second data includes a feedback viewing profile of each viewer of the first group of secondary viewers.

3. The automated collaborative filtering method of claim 1, wherein:
the first data includes a feedback viewing history of the primary viewer; and
the second data includes a feedback viewing history of each viewer of the first group of secondary viewers.

4. The automated collaborative filtering method of claim 1, wherein:
the first data includes an implicit viewing profile of the primary viewer; and
the second data includes an implicit viewing profile of each viewer of the first group of secondary viewers.

5. The automated collaborative filtering method of claim 1, wherein:
the first data includes an implicit viewing history of the primary viewer; and
the second data includes an implicit viewing history of each viewer of the first group of secondary viewers.

6. The automated collaborative filtering method of claim 1, wherein:
the first data includes an explicit viewing profile of the primary viewer; and
the second data includes an explicit viewing profile of each viewer of the first group of secondary viewers.

7. The automated collaborative filtering method of claim 1, further comprising:
matching the first data to a subset of a fourth data, the fourth data indicative of a viewing of a third group of items by a second group of secondary viewers;
wherein the recommendation of the first item is generated as a function of the third data, the subset of the second data, and the subset of the fourth data.

8. The automated collaborative filtering method of claim 7, further comprising:
matching the first data to a subset of a fifth data, the fifth data indicative of a viewing of a fourth group of items by a third group of secondary viewers,
wherein the recommendation of the first item is generated as a function of the third data, the subset of the second data, the subset of the fourth data, and the subset of the fifth data.

9. An automated collaborative filtering system for providing a recommendation of a first item to a primary viewer, said system comprising:
a first module for matching the first data to a subset of the second data, the first data being indicative of a viewing of a first group of items by the primary viewer, the second data being indicative of a viewing of a second group of items by the first group of secondary viewers; and
a second module for generating the recommendation of the first item as a function of a third data and the subset of the second data,
wherein the third data is indicative of one or more attributes of the first item.

10. The automated collaborative filtering system of claim 9, wherein:
the first data includes a feedback viewing profile of the primary viewer; and
the second data includes a feedback viewing profile of each viewer of the first group of secondary viewers.

11. The automated collaborative filtering system of claim 9, wherein:
the first data includes a feedback viewing history of the primary viewer; and
the second data includes a feedback viewing history of each viewer of the first group of secondary viewers.

12. The automated collaborative filtering system of claim 9, wherein:
the first data includes an implicit viewing profile of the primary viewer; and
the second data includes an implicit viewing profile of each viewer of the first group of secondary viewers.

13. The automated collaborative filtering system of claim 9, wherein:
the first data includes an implicit viewing history of the primary viewer; and
the second data includes an implicit viewing history of each viewer of the first group of secondary viewers.

14. The automated collaborative filtering system of claim 9, wherein:
the first data includes an explicit viewing profile of the primary viewer; and
the second data includes an explicit viewing profile of each viewer of the first group of secondary viewers.

15. The automated collaborative filtering system of claim 9, further comprising:
a third module for matching the first data to a subset of a fourth data, the fourth data being indicative of a viewing of a third group of items by a second group of secondary viewers,
wherein said second module is operable to generate the recommendation of the first item as a function of the third data, the subset of the second data, and the subset of the fourth data.

16. The automated collaborative filtering system of claim 15, further comprising:
a fourth module for matching the first data to a subset of a fifth data, the fifth data being indicative of a viewing of a fourth group of items by a third group of secondary viewers,
wherein said second module is operable to generate the recommendation of the first item as a function of the third data, the subset of the second data, the subset of the fourth data, and the subset of the fifth data.

17. Computer program product in a computer readable medium for providing a recommendation of a first item to a primary viewer, said computer program product comprising:
a first computer readable code for matching a first data to a subset of a second data, the first data being indicative of a viewing of a first group of items by the primary viewer, the second data being indicative of a viewing of a second group of items by a first group of secondary viewers; and
a second computer readable code for generating the recommendation of the first item as a function of a third data and the subset of the second data,
wherein the third being data is indicative of one or more attributes of the first item.

18. The computer readable product of claim 17, wherein:
the first data includes a feedback viewing profile of the primary viewer; and
the second data includes a feedback viewing profile of each viewer of the first group of secondary viewers.

19. The computer readable product of claim 17, wherein:
the first data includes a feedback viewing history of the primary viewer; and
the second data includes a feedback viewing history of each viewer of the first group of secondary viewers.

20. The computer readable product of claim 17, wherein:
the first data includes an implicit viewing profile of the primary viewer; and
the second data includes an implicit viewing profile of each viewer of the first group of secondary viewers.

21. The computer readable product of claim 17, wherein:
the first data includes an implicit viewing history of the primary viewer; and
the second data includes an implicit viewing history of each viewer of the first group of secondary viewers.

22. The computer readable product of claim 17, wherein:
the first data includes an explicit viewing profile of the primary viewer; and
the second data includes an explicit viewing profile of each viewer of the first group of secondary viewers.

23. The computer readable product of claim 17, further comprising:
a third computer readable code for matching the first data to a subset of a fourth data, the fourth data being indicative of a viewing of a third group of items by a second group of secondary viewers,
wherein said second computer readable code is for generating the recommendation of the first item as a function of the third data, the subset of the second data, and the subset of the fourth data.

24. The computer readable product of claim 23, further comprising:
a fourth computer readable code for matching the first data to a subset of a fifth data, the fifth data being indicative of a viewing of a fourth group of items by a third group of secondary viewers,
wherein said second computer readable code is for generating the recommendation of the first item as a function of the third data, the subset of the second data, the subset of the fourth data, and the subset of the fifth data.

25. An automated collaborative filtering system for providing a recommendation of an item to a primary viewer, said system comprising:
means for matching a first data to a subset of the second data, the first data being indicative of a viewing of a group of items by the primary viewer, the second data being indicative of a viewing of a second group of items by the group of secondary viewers; and
means for generating the recommendation of the item as a function of a third data and the subset of the second data,
wherein the third data being indicative of one or more attributes of the item.
